(19) United States
(12) Patent Application Publication
(10) Pub. No.: US 2014/0372246 A1
(43) Pub. Date: Dec. 18, 2014

(54) Fund Raising Business Method Employing Articles of Personal Adornment

(71) Applicants: Peter Ettenborough, Newburyport, MA (US); Anthony Peluso, Fairport, NY (US)

(72) Inventors: Peter Ettenborough, Newburyport, MA (US); Anthony Peluso, Fairport, NY (US)

(21) Appl. No.: 14/303,017

(22) Filed: Jun. 12, 2014

Related U.S. Application Data
(60) Provisional application No. 61/834,010, filed on Jun. 12, 2013.

(51) Int. Cl. G06Q 30/02; G06Q 30/06

(52) U.S. Cl. CPC G06Q 30/0279; G06Q 30/0621
USPC 705/26.5

(57) ABSTRACT

A computer implemented fund raising method for a donatable entity/organization employing the marketing of one or more articles of personal adornment such as bracelets, necklaces, earrings, key chains, and the like which are composed of, at least in part, a pattern of a group of selected colored elements in a selected order which are chosen by the entity as their unique combination; the selection, a registry of selected and available items, sales, manufacturing, delivery, and donation all managed and implemented by an internet web site in conjunction with a computer server.

### CROSS REFERENCE TO RELATED APPLICATIONS

This application is based on Provisional Application Ser. No. 61/834,010 filed Jun. 12, 2013 by the same inventors which is hereby incorporated by reference.

### BACKGROUND OF THE INVENTION

1. Field of the Invention

The invention relates to computer implemented business methods for fund raising for donatable entities.

2. Description of the Prior Art

The sale of products by donatable entities to raise money for their operations and purposes is a well known practice. Such entities include a wide array of individuals and organizations, in particular, the general class of non-profits and more specifically charitable groups, public institutions, fraternal societies, and special interest clubs.

Businesses supplying these salable items on custom order are also well known. However, in the standard practice, the entity itself must arrange for the purchase and sale of the products, requiring an investment of upfront money and additional overhead expense.

The products most often employed in these sales are first utilitarian and second identify the entity in a printed format, i.e., a name, slogan, or logo. These products include, for example, clothing, particularly T-shirts and sweatshirts, carry bags, coffee mugs, pens and pencils, matchbooks, and refrigerator magnets.

Suppliers and sellers of these items are typically carried out by separate groups of people. The organization or entity intending to engage in this type of fund raising will contact a business specializing in custom printing of the identity of the group as well as other information such as web sites, telephone numbers or location. The amount of printing and information is necessarily limited by the size and style of the article.

Arrangements will be made between the parties to provide a selected quantity of whatever products are chosen for delivery to the entity usually requiring payment in advance. Additional reorders will follow the same procedure requiring the organization to commit to a minimum quantity and prepayment. In addition, the entity will have the burden of selling and distributing the products involving the possible disadvantages of involving multiple personnel, diversity of location, collecting and accounting for money as well as bookkeeping tasks.

In contrast to the prior art as best known to the applicants, the fund raising method disclosed herein eliminates many of the difficulties inherent in the traditional approach of an organization custom ordering printed or embossed articles from suppliers followed by sales and distribution activities by the organization itself.

The following summary of the invention outlines the steps that are involved in carrying out the method.

### SUMMARY OF THE INVENTION

The invention may be summarized as a fund raising method for a donatable entity which employs an article of personal adornment utilizing, at least in part, a plurality of selected colored elements arranged in a unique selected order in a pre-established pattern as a symbol of the identity of the entity. There are three participants in the process, i.e., the donatable entity or organization, the producer or operator of the business, and the purchasers of the finished articles. The producer provides the basic computer implemented service linking the entity and the purchasers through a publicly accessible internet web site at which an entity may select a plurality of colored elements and a unique order in which they will appear in the finished article. A registry of previously chosen unique combinations which are no longer available is accessible through the site resulting in the pending combination either being authorized or declined requiring a different selection.

Once a unique selection is reached, it is entered on the registry as the entity's unique combination and the finished article then manufactured and made available to the public for purchase through the web site. The producer will process orders for the article and arrange for delivery. The producer then forwards a portion of the proceeds from such sales to the donatable entity.

Each of the above steps will be discussed in further detail in the description of the preferred embodiment accompanied by the drawing below.

### DESCRIPTION OF THE DRAWING

FIG. 1 is a flow chart illustrating the steps of a preferred embodiment of the process of the process of the invention; and

FIG. 2 is a schematic drawing of one article used in conjunction with the preferred embodiment of the invention.

### DESCRIPTION OF THE PREFERRED EMBODIMENT

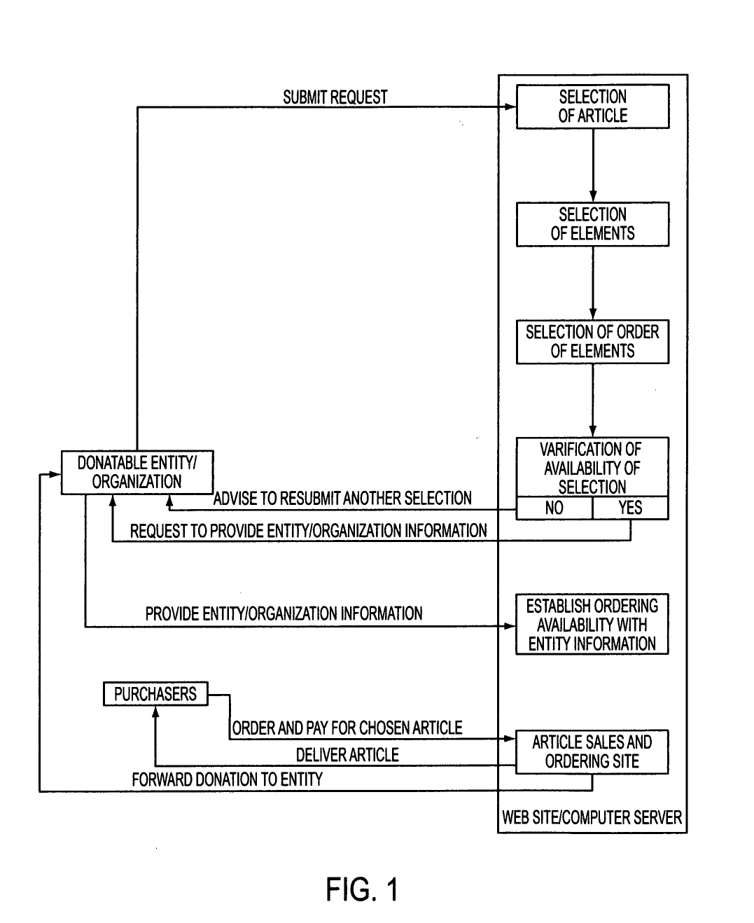

Referring to the flow chart of FIG. 1, an organization or donatable entity capable of receiving a charitable contribution is made aware of the service provided by the method of the invention. This may happen, for example, through advertising, direct solicitation, observing one of the types of articles available in use, or word of mouth.

The entity then contacts the producer or provider of the service employing the method through a website communicating with and operationally connected to a computer web server. One or more articles of personal adornment designed with a pattern of arrangement as well as a plurality of selectable colored elements organizable into a selected order are presented for the entity's selection to create a unique combination for the article which will become exclusive to the entity and will fit into the article's design pattern.

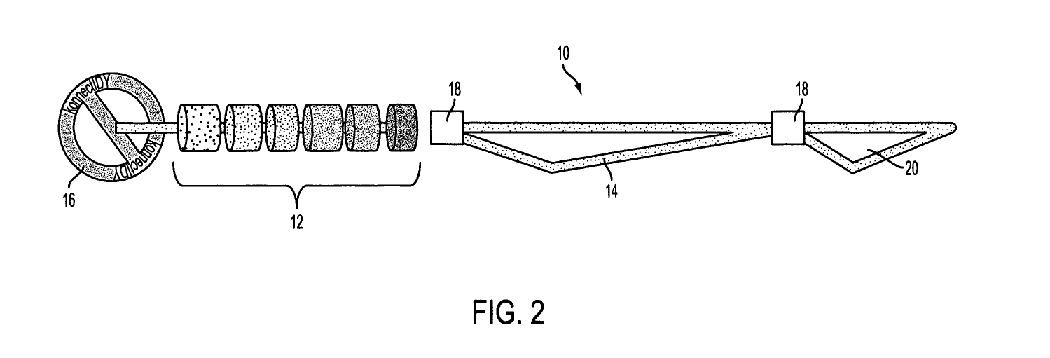

As an example, FIG. 2 illustrates a colored beaded bracelet 10 suitable as a product or article for employment using the method of the invention. The colored beads 12 (which colors may also include black, white, and one or more shades of gray) are the colored elements, the pattern is a straight line, and the order is as it appears. The elastic cord 14 constitutes a base to which the elements are added in the order prescribed. The orientation, i.e., left to right or right to left is indicated by a reference tag 16 at either end of the string. Crimping beads 18 secure the assembly. The loop 20 that is created at one end of the bracelet is arranged to receive the reference tag 18 to secure the bracelet around a wrist. Other articles which would be suitable include earrings, pins, necklaces, key chains, or any other article which would be seen, worn, or used about a person.

A great benefit of these articles is that they will be seen by others and as such can prompt inquiry and a conversation about the organization and where they might be ordered.

The computer server then interrogates a registry of other combinations already in use as they have been established by other entities employing this service and approves or rejects the proposed combination. If rejected, the entity is advised to make another selection of elements and order. If accepted the entity is then requested to supply information about itself to be included in the sales and ordering portion of the web site as the entity desires.

The unique article is then added to the web site from which it may be ordered by the public at large. The computer server connected to the web site will process ordering and payment. Manufacturing of the finished articles are initiated by the service provider on an as needed basis either as ordered or ahead of time in anticipation of orders as the provider deems fit.

Finished articles are then shipped to purchasers and a donation of a pre-agreed amount forwarded to the entity.

The invention is accordingly defined by the following claims.

What is claimed is:

1. A computer implemented fund raising method for a donatable entity employing an article of personal adornment comprising in combination the steps of:
A. providing a base assembly for said article;
B. providing a plurality of various selectable colored elements mountable on said base assembly in a pattern arranged to identify said donatable entity according to a selected order in which said elements are mounted;
C. providing an internet web site operationally connected to a computer server for said entity to select and record a plurality of said elements in a unique order to identify said entity;
D. mounting said selected elements in said selected unique order on said base assembly to create said article of personal adornment;
E. offering and selling said article on said web site; and
F. donating a portion of the proceeds of such sales to said entity.

2. The method of claim 1 wherein said web site further includes accessible information relating to said entity.

3. The method of claim 2 wherein said computer server is configured to:
A. present at least one of said articles for consideration and selection;
B. present a plurality of said elements for consideration and selection;
C. provide for a selection of an order in which said selected elements will appear in combination in said article;
D. provide a registry of previously selected combinations of elements and order;
E. accept and record combinations not previously selected;
F. provide an offer for sale, ordering, and payment function for selected combinations; and
G. obtain information relating to said entity and integrating said information with said offer for sale.

4. The method of claim 1 wherein said article constitutes a bracelet and said elements constitute beads.
